(19) United States
(12) Patent Application Publication
(10) Pub. No.: US 2017/0195506 A1
(43) Pub. Date: Jul. 6, 2017

(54) IMAGE FORMING APPARATUS FORMING LOCATION FREE PRINT SYSTEM AND PRINT JOB RETRIEVAL METHOD BY THE SAME

(71) Applicants: KABUSHIKI KAISHA TOSHIBA, Tokyo (JP); TOSHIBA TEC KABUSHIKI KAISHA, Tokyo (JP)

(72) Inventor: Yuichi Kato, Susono Shizuoka (JP)

(21) Appl. No.: 14/983,957

(22) Filed: Dec. 30, 2015

(51) Int. Cl. H04N 1/00; G06F 3/12; H04N 1/32

(52) U.S. Cl. CPC H04N 1/00347; H04N 1/00244; H04N 1/32523; G06F 3/1205; G06F 3/1267; G06F 3/1238; G06F 3/1263; H04N 2201/0094

(57) ABSTRACT

An image forming apparatus forms a location free print system in which the groups of networks made up of a plurality of image forming apparatuses include a plurality of groups in which one image forming apparatus functions as a main server and an address list of addresses of main servers of all groups is shared by the main server of each group. A job list of print jobs of the image forming apparatuses is shared by each image forming apparatus in the first group. If a user is authenticated, then the image forming apparatus retrieves print jobs of the user registered in the first group from the job list. If retrieving print jobs of the user registered in a second group, the image forming apparatus instructs, via a main server of the first group, a main server of the second group to retrieve print jobs of the user.

### FIELD

Embodiments described herein relate generally to an image forming apparatus forming a location free print system.

### BACKGROUND

In a location free print system, a user registers a print job in a server from a client terminal. The user can print the print job registered by the user or delete the print job from the server from any image forming apparatus on a network.

A system is being developed in recent years which endows a multifunction peripheral with the print job storage function of a server and is therefore server-less.

However, it is designed that a network can only be made up of at most around 10 image forming apparatuses in the system, leading to a problem that a network made up of more image forming apparatuses is unachievable.

### DESCRIPTION OF THE DRAWINGS

FIG. 1 is a diagram illustrating the structure of a server-less location free print system;

FIG. 2 is a diagram illustrating an address list;

FIG. 3 is a diagram illustrating a priority list;

FIG. 4 is a flowchart illustrating a print job registration processing;

FIG. 5 is a diagram illustrating a job list;

FIG. 6 is a flowchart illustrating a print job execution processing;

FIG. 7 is a diagram illustrating a retrieval result screen;

FIG. 8 is a diagram illustrating a retrieval result screen;

FIG. 9 is a diagram illustrating a print system;

FIG. 10 is a diagram illustrating a high-order address list; and

FIG. 11 is a flowchart illustrating a print job execution processing.

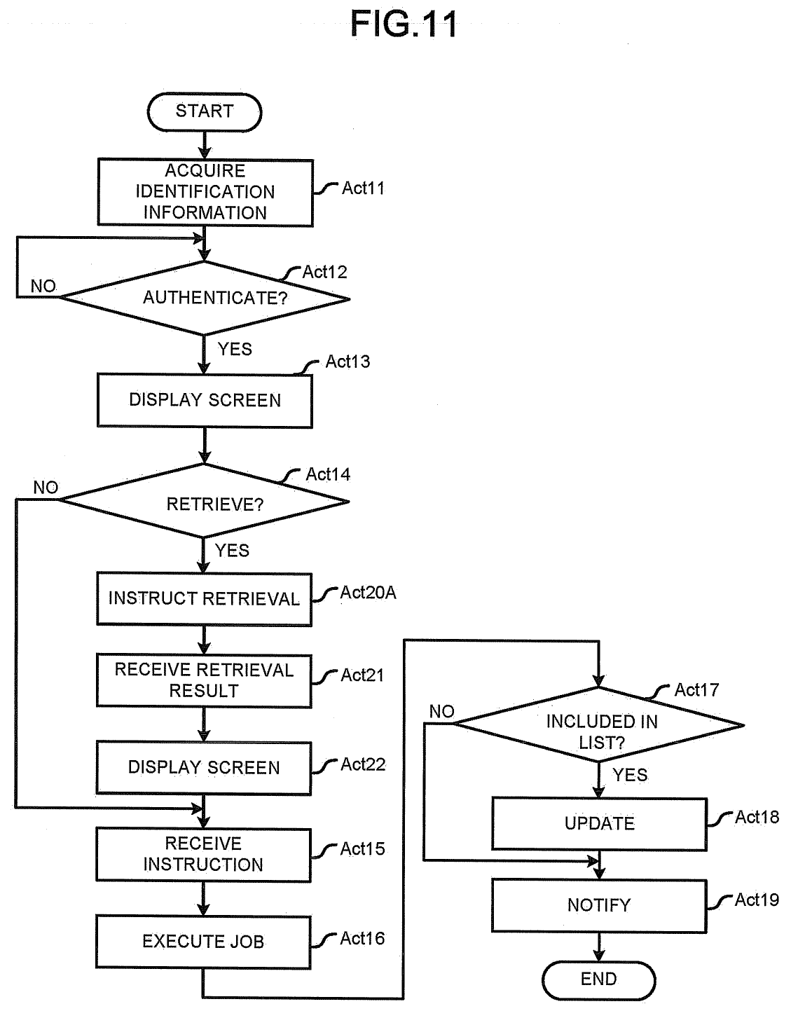

### DETAILED DESCRIPTION

The image forming apparatus according to an embodiment described herein can form a location free print system. In the location free print system, the groups of networks made up of a plurality of image forming apparatuses include a plurality of groups in which one image forming apparatus functions as a main server. An address list of addresses of main servers of all groups is stored in the main server of each group. A job list of print jobs of the image forming apparatuses included in a first group the image forming apparatus belongs to is shared by each image forming apparatus in the first group. If a user is authenticated, then the image forming apparatus retrieves print jobs of the user registered in the first group from the job list . To retrieve print jobs of the user registered in a second group different from the first group, the image forming apparatus instructs, via the main server of the first group, the main server of the second group to retrieve print jobs of the user.

### A First Embodiment

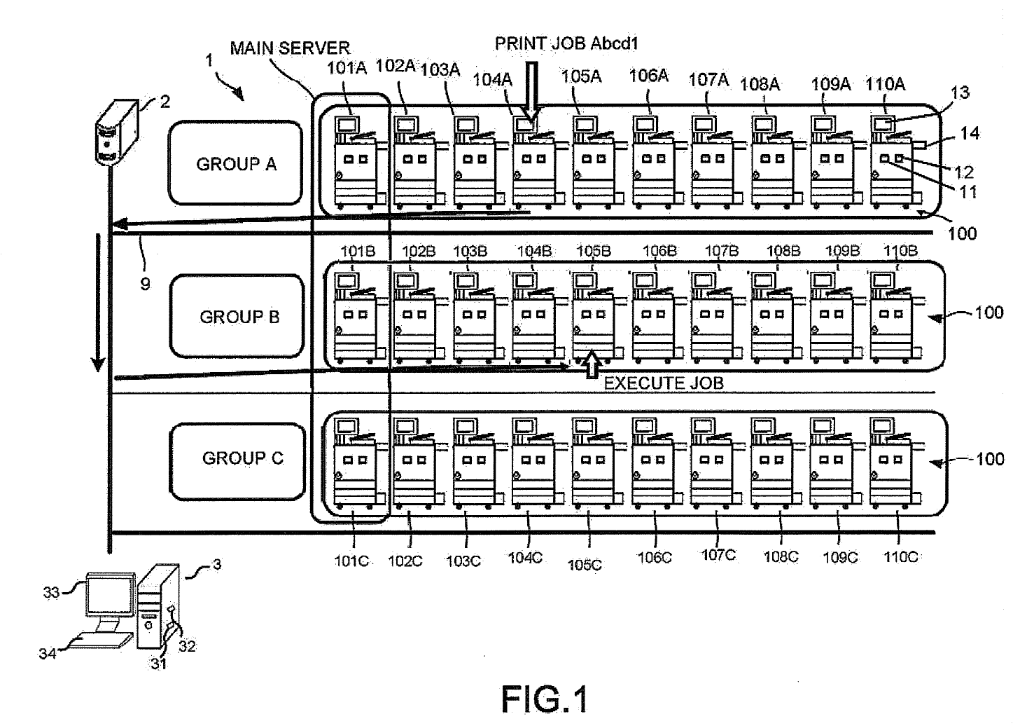

FIG. 1 is a diagram illustrating the structure of a server-less location free print system 1 (hereinafter referred to as a print system 1).

The print system 1 comprises image forming apparatuses 100, an authentication server 2 and a client terminal 3, which are connected with each other through a network 9.

The image forming apparatus 100 is, for example, an MFP (Multi-Function Peripheral) having a plurality of functions including a print function and a FAX function. The image forming apparatuses 100 are hereinafter jointly referred to as ‘the image forming apparatus 100’ if not required to be specially distinguished from each other or ‘image forming apparatuses 101A-110A’, ‘image forming apparatuses 101B-110B’ and ‘image forming apparatuses 101C-110C’ if required to be distinguished from each other. Users are hereinafter jointly referred to as ‘the user’ if it is not needed to distinguish between different users or ‘users X-Z ’ if it is needed to distinguish between different users.

The image forming apparatus 100 comprises a processor 11, a memory 12, a display section 13, an input section 14 and a card reader (not shown).

The processor 11 reads the programs stored in the memory 12 to enable the image forming apparatus 100 to carry out various processing. The display section 13 displays setting information, an operation status, log information and a notice output to the user. The display section 13 is a touch panel which also additionally functions as an input section for receiving an input from the user. The input section 14 which comprises buttons and keys receives an input from the user. The card reader reads the ID (Identification) card of a user to acquire the identification information of the user.

The authentication server 2 is used for user login, user management and user authentication.

The client terminal 3 is, for example, a PC (Personal Computer). The client terminal 3 comprises a processor 31, a memory 32, a display section 33, an input section 34 and a card reader (not shown). The processor 31 reads the programs stored in the memory 32 to enable the client terminal 3 to carry out various processing. The display section 33 displays a screen. The input section 34 which is a keyboard or a mouse receives an input from the user. The card reader reads the ID card of a user to acquire the identification information of the user. The plurality of client terminals 3 is connected with the print system 1 to register print jobs in proper image forming apparatuses 100.

In the print system 1, ten image forming apparatuses 101A-110A constitute a network, forming a group A. Ten image forming apparatuses 101B-110B constitute a network, forming a group B. Ten image forming apparatuses 101C-110C constitute a network, forming a group C. It is described in the embodiment that three groups of networks are formed by the plurality of image forming apparatuses 101A-110A, 101B-110B and 101C-110C. However, the number of the groups may be more than two. Additionally, the number of the image forming apparatuses forming each group may be more than two.

The functions of the conventional location free print system are available in groups A-C.

In the group A consisting of image forming apparatuses 101A-110A, the image forming apparatus 101A functions as a main server; in the group B consisting of image forming apparatuses 101B-110B, the image forming apparatus 101B functions as a main server, and in the group C consisting of image forming apparatuses 101C-110C, the image forming apparatus 101C functions as a main server. The image forming apparatuses 101A, 101B and 101C are hereinafter referred to as main servers 101A, 101B and 101C.

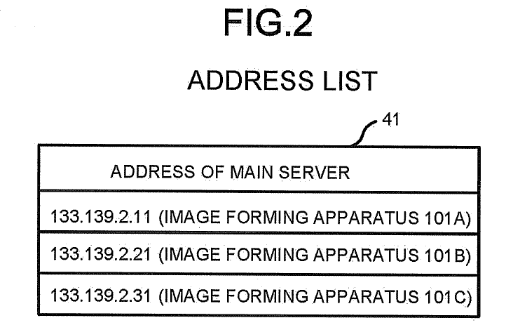

The main servers 101A, 101B and 101C share the address list 41 (FIG. 2) of the main servers 101A, 101B and 101C.

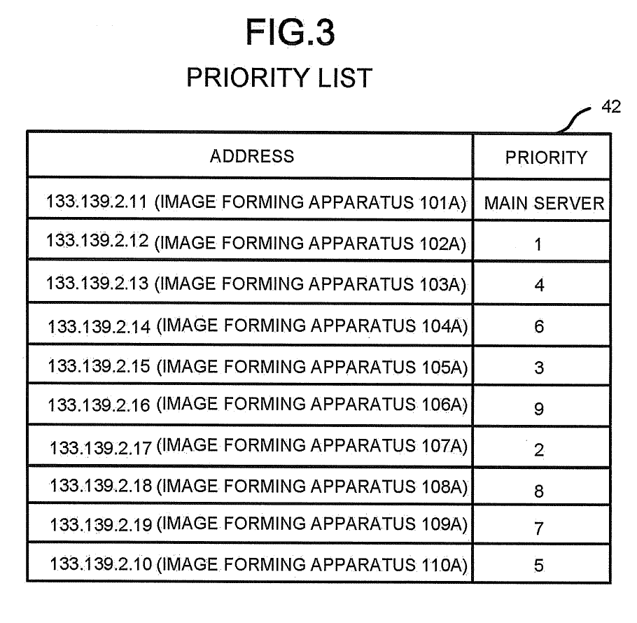

The image forming apparatuses 101A-110A constituting the group A share a priority list 42 (FIG. 3). The priority list 42 (FIG. 3) specifies the priority of each of the image forming apparatuses 101A-110A in realizing the functions of the main server 101A when the main server 101A is powered off.

The priority list 42 also specifies the current main server 101A. The priority list 42 specifies the image forming apparatuses 101A-110A based on address. The priority list 42 also includes an address list of addresses of the image forming apparatuses 101A-110A constituting the group A. The address refers to the identification mark of each of the image forming apparatuses 101A-110A, including an IP (Internet Protocol) address and a MAC (Media Access Control) address.

The image forming apparatuses 101B-110B constituting the group B and the image forming apparatuses 101C-110C constituting the group C also share the priority list 42.

A print processing based on the print system 1 is described below. First, the registration of a print job carried out by the image forming apparatus 101A of the group A is described as an example. In the processing described below, the image forming apparatus 100 and the client terminal 3 carry out various processing through the execution of the programs stored in the memories 12 and 22 by the processors 11 and 21.

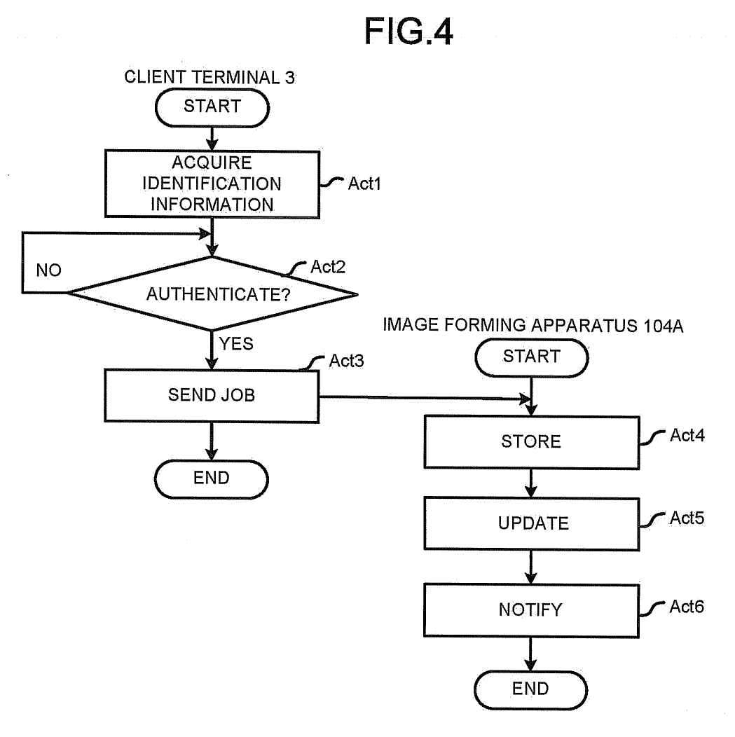

The print processing is described below with reference to the flowchart shown FIG. 4.

A user X places an ID card in which identification information is stored above the card reader of the client terminal 3 so that the user can be authenticated. The client terminal 3 acquires the identification information of the user X and sends the identification information of the user X to the authentication server 2 (Act 1). The authentication server 2 verifies, based on the identification information sent from the client terminal 3, whether or not the user X has a right to operate the client terminal 3. If the user X is authenticated by the authentication server 2 (Act 2: Yes), the client terminal 3 starts a printer driver according to an input from the user X to, for example, send a print job Abcd1 and an instruction for the registration of the print job Abcd1 to the image forming apparatus 104A included in the group A (Act 3).

The image forming apparatus 104A receives the print job Abcd1 and the instruction for the registration of the print job Abcd1, associates the print job Abcd1 with the user X and stores the print job Abcd1 in the memory 12 (Act 4).

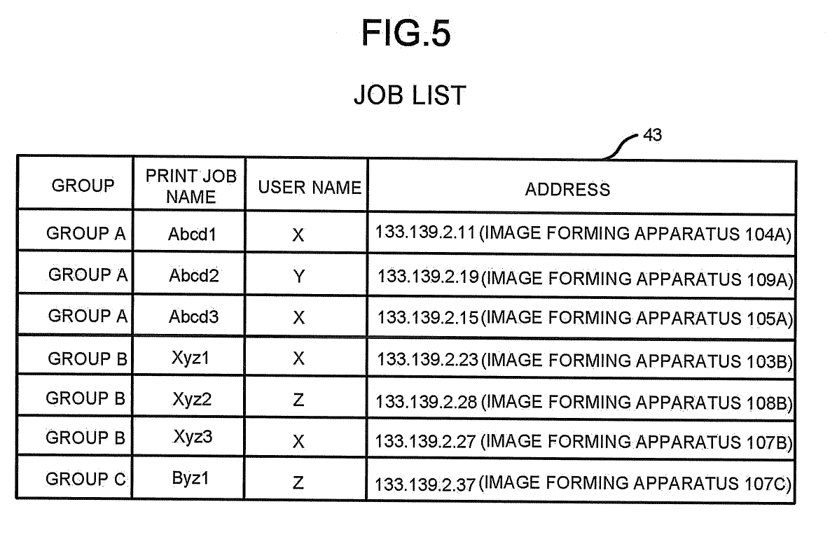

Herein, a job list 43 (FIG. 5) of print jobs of the image forming apparatuses 101A-110A is shared by each of the image forming apparatuses 101A-110A. In the job list 43, the user name is associated with the address of the one of the image forming apparatus 101A-110A responsible for the print job with respect to the name of the print job.

The image forming apparatus 104A adds the print job Abcd1 into the job list 43 and updates the job list 43 (Act 5).

The image forming apparatus 104A notifies the other image apparatuses (101A-110A except for 104A) of the update of the job list 43 (Act 6) . In this way, the other image apparatuses (101A-110A except for 104A) update the job lists 43 thereof to be the same as the job list 43 of the image forming apparatus 104A.

The image forming apparatuses 101B-110B included in the , group B also have a job list 43 of print jobs of each of the image forming apparatuses 101B-110B. The image forming apparatuses 101C-110C included in the group C also have a job list of print jobs of the image forming apparatuses 101C-110C.

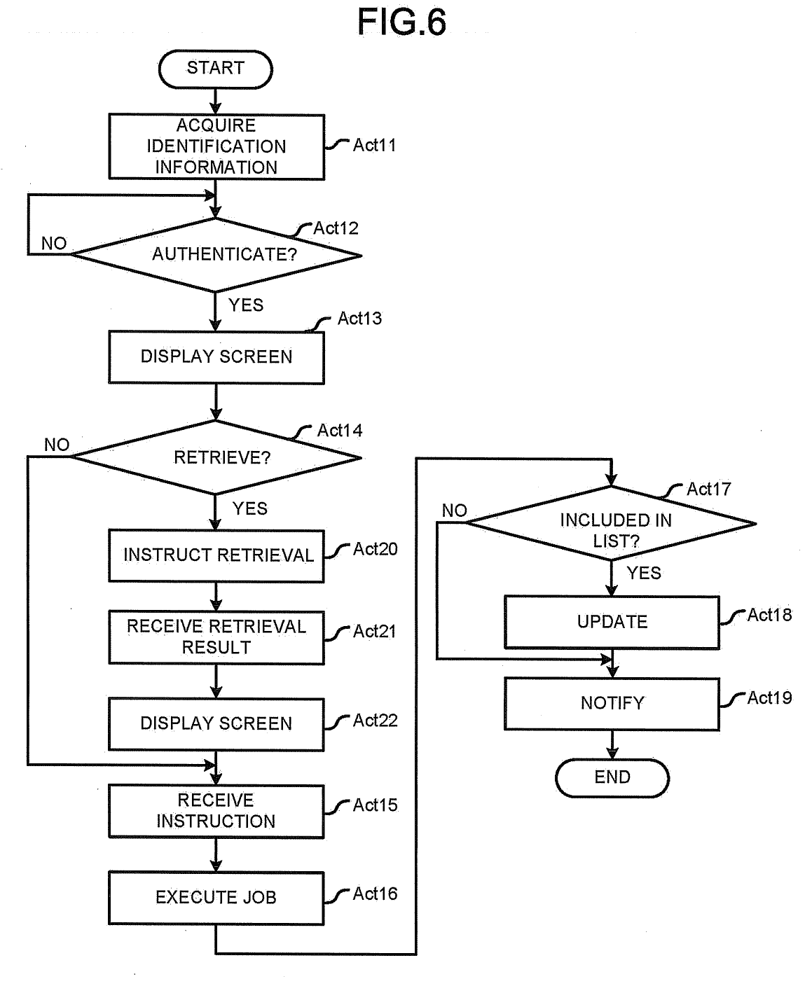

Reference is made to the flowchart shown in FIG. 6 below.

Next, an example of the execution of the print job Abcd1 by the image forming apparatus 105B in the group B different from the group A to which the image forming apparatus 104A which carries out the registration of the print job Abcd1 belongs by the user X is described.

It is assumed that the user X registers the print job Abcd1 in the image forming apparatus 104A of the group A through the client terminal 3 and moves to the image forming apparatus 105B of the group B to execute the print job Abcd1.

The user X places an ID card above the card reader of the image forming apparatus 105B so that the user can be authenticated. The image forming apparatus 105B acquires the identification information of the user X and sends the identification information of the user X to the authentication server 2 (Act 11) .

The authentication server 2 verifies, based on the identification information sent from the image forming apparatus 105B, whether or not the user X has a right of executing a location free print job.

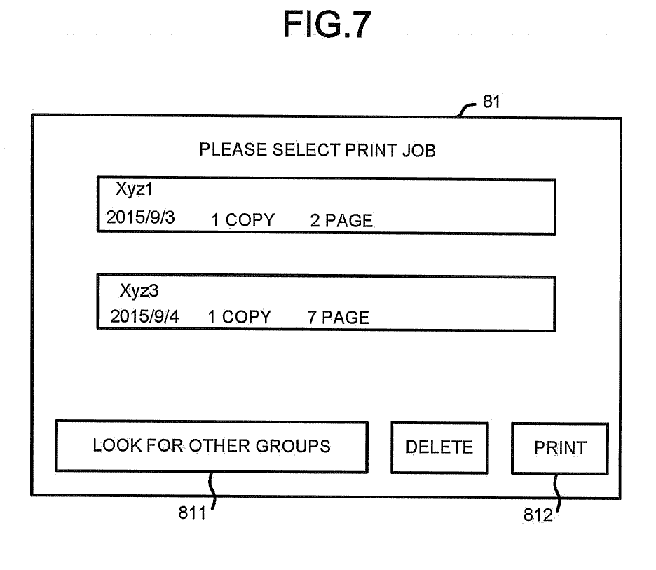

If the user X is authenticated by the authentication server 2 (Act 12: Yes), the image forming apparatus 105B retrieves print jobs of the user X from the job list 43. The image forming apparatus 105B displays a retrieval result screen 81 (refer to FIG. 7) on which print jobs of the user X registered in the group B are displayed (Act 13). In this case, the image forming apparatus 105B refuses to retrieve the print jobs of the user X registered in the other groups A and C. Thus, the print job Abcd1 desired by the user X to be executed is not displayed on the retrieval result screen 81.

Then, the user X presses a button 811 for retrieval in the other groups A and C (Act 14: Yes).

The image forming apparatus 105B instructs the main server 101B of the group B to retrieve print jobs of the user X registered in the other groups A and C (Act 20).

Based on the address list 41 (FIG. 2), the main server 101B of the group B instructs the main servers 101A and 101C of the other groups A and C to retrieve print jobs of the user X.

The main servers 101A and 101C of the other groups A and C separately retrieve print jobs of the user X from the job lists 43 and send retrieval results to the main server 101B of the group B. The names of the print jobs associated with the user name X and the addresses of the image forming apparatuses in which the print jobs are registered in the job lists 43 are included in the retrieval result. The retrieval result from the main server 101A of the group A contains information indicating that the print job Abcd1 desired by the user X to be executed is registered in the image forming apparatus 104A.

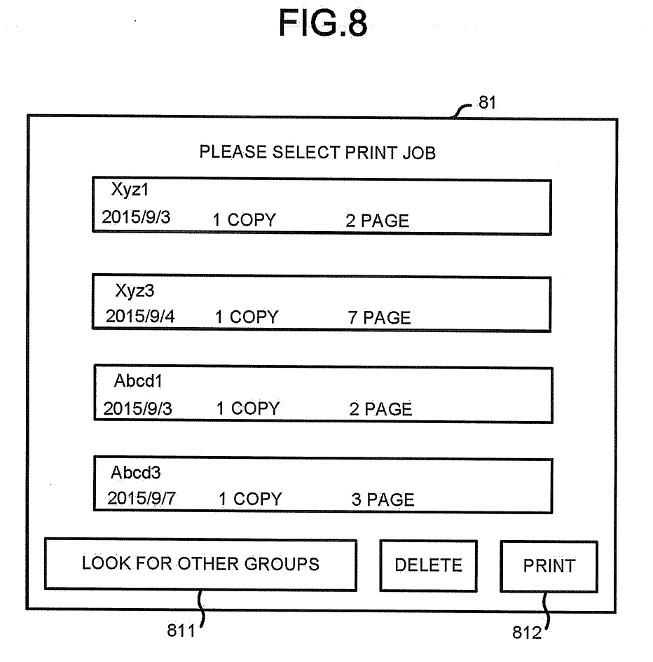

The image forming apparatus 105B receives the retrieval results (Act 21) and displays a retrieval result screen 81 (refer to FIG. 8) on which the print jobs of the user X registered in the group A-C are displayed (Act 22).

The user X selects the executed print job Abcd1 and presses a ‘print’ button 812. In this way, the image forming apparatus 105B receives an instruction for the execution of the print job Abcd1 (Act 15).

The image forming apparatus 105B executes the selected print job Abcd1 (Act 16). In this case, as the selected print job Abcd1 is not registered in the image forming apparatus 105B, the image forming apparatus 105B instructs, via the main server 101B of the group B, the main server 101A of the group A to acquire the print job Abcd1. The main server 101A acquires the print job Abcd1 from the image forming apparatus 104A based on the job list 43. The main server 101A sends the print job Abcd1 to the image forming apparatus 105B via the main server 101B of the group B.

Further, the image forming apparatus 105B may directly acquire the print job Abcd1 from the image forming apparatus 104A in which the print job Abcd1 is registered based on the retrieval result sent from the main server 101A of the group A. This is because that the address of the image forming apparatus 104A in which the print job Abcd1 is registered is included in the retrieval result.

The image forming apparatus 105B maintains the job list 43 as the executed print job Abcd1 is not included in the job list 43 (Act 17: No).

The image forming apparatus 105B notifies, via the main server 101B of the group B, the main server 101A of the group A of the execution of the print job Abcd1 (Act 19). The main server 101A deletes the print job Abcd1 from the job list 43. The other image apparatuses (101A-110A except for 101A) of the group A update the job lists 43 thereof to be the same as the print job 43 of the image forming apparatus 101A.

An example of the execution of a print job Xyz1 registered in the image forming apparatus 103B by the user X using the image forming apparatus 105B belonging to the same group with the image forming apparatus 103B is described. In this case, as the print job Xyz1 the user wants to execute is displayed on the retrieval result screen 81 displayed in Act 13, a button 811 for retrieval in the other groups A and C is not pressed by the user X (Act 14: No). The operations subsequent to Act 15 are the same as those described above.

The processing carried out by the one of the image forming apparatuses 101A-110A having the highest priority when the main server 101A is powered off, the processing carried out by the one of the image forming apparatuses 101B-110B having the highest priority when the main server 101B is powered off and the processing carried out by the one of the image forming apparatuses 101C-110C having the highest priority when the main server 101C is powered off are described below. The image forming apparatus 102A in the group A is described as the one of the image forming apparatuses 101A-110A having the highest priority when the main server 101A is powered off.

The main server 101A of the group A carries out the following processing before being powered off: the main server 101A notifies, based on the priority list 42 (FIG. 3), the image forming apparatus 102A having the highest priority that the main server 101A is to be powered off.

If receiving the notice indicating that the main server 101A is to be powered off, the image forming apparatus 102A functions as a main server based on the priority list 42. Then, the image forming apparatus 102A updates the priority list 42 to specify the role thereof as a main server and upgrade the priority of each of the image forming apparatuses 101A-110A by one level.

The image forming apparatus 102A notifies the other image forming apparatuses 101A-110A (101A-110A except for 102A) of the role thereof as a main server.

The other image apparatuses (101A-110A except for 102A) update the priority lists 42 thereof to be the same as the priority list 42 of the image forming apparatus 102A serving as a main server.

### A Second Embodiment

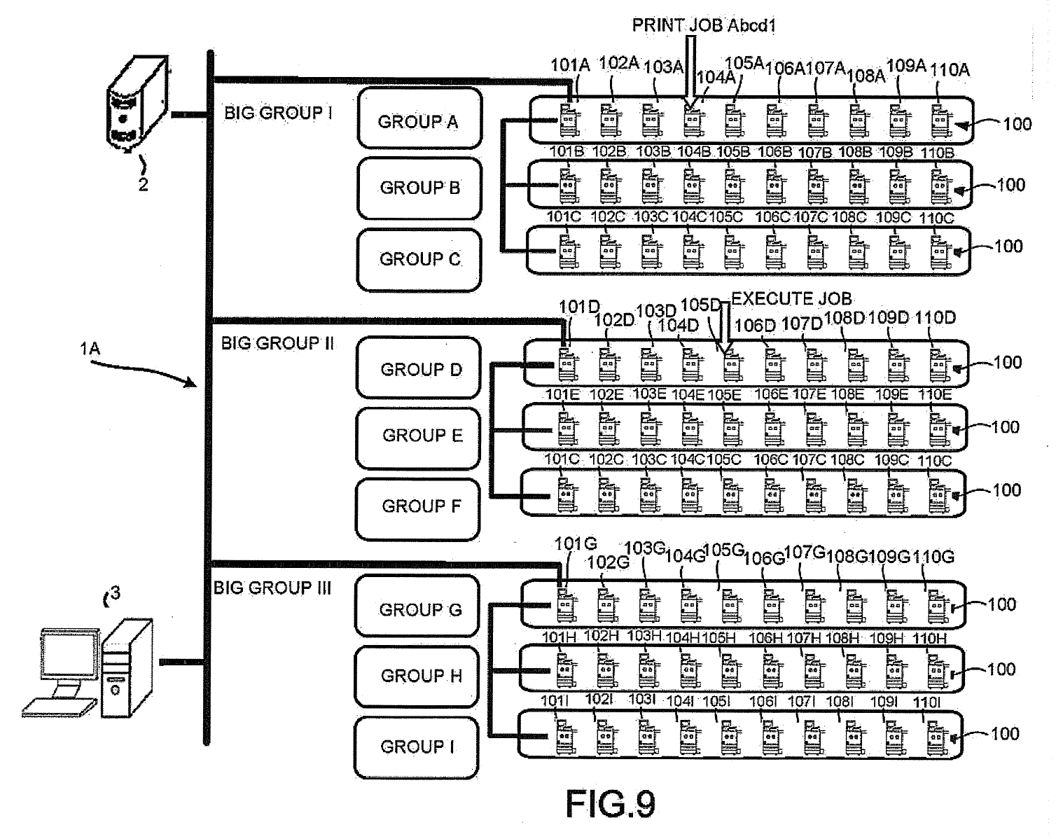

FIG. 9 is a diagram illustrating a print system 1A.

The print system 1A comprises a plurality of super groups each consisting of a plurality of groups. The print system 1A comprises a super group I consisting of the groups A-C described in the first embodiment, a super group II consisting of groups D-F identical to the groups A-C and a super group III consisting of groups G-I identical to the groups A-C.

Each of the groups A-I is composed of 10 image forming apparatuses 100. A job list of print jobs of the image forming apparatuses of the groups A-I is shared by each image forming apparatus 100.

Among the main servers 101A-101I belonging to the super groups I, II and III, main servers 101A, 101D and 101G function as high-order servers.

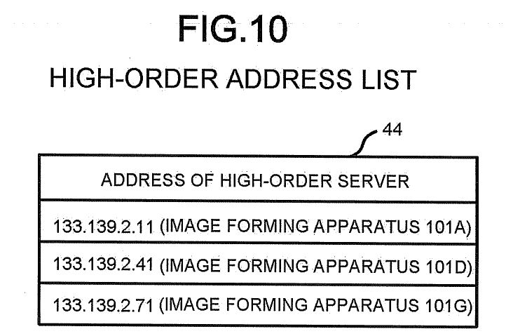

High-order address lists 44 (FIG. 10) of high-order addresses of the high-order servers 101A, 101D and 101G of the super groups I, II and III are separately stored in the high-order servers 101A, 101D and 101G.

In the print system 1A, if a print job is registered and executed in the same super group I, II or III, then the registration and the execution of the print job are carried out in the same manner as described in the first embodiment.

An example of the execution of a print job Abcd1 by a user X using the image forming apparatus 105D belonging to the super group II which is different from the super group I the image forming apparatus 104A in which the print job Abcd1 is registered belongs to is described. The operations carried out in the example are identical to those shown in FIG. 6 except for Act 20A which is different from Act 20 shown in FIG. 6.

The image forming apparatus 105D retrieves print jobs of the user X in the group D based on the job list and displays a retrieval result on the retrieval result screen 81 (Act 13) . In this case, the image forming apparatus 105D refuses to retrieve print jobs of the user X registered in the other groups E and F of the super group II. Further, the image forming apparatus 105D refuses to retrieve print jobs of the user X registered in the other super groups I and III. Thus, the print job Abcd1 the user X wants to execute is not displayed on the retrieval result screen 81.

Then, the user X presses the button 811 to retrieve print jobs from the other groups E and F of the super group II and the other super groups I and III (Act 14: Yes).

The image forming apparatus 105D instructs, via the high-order server 101D which additionally functions as the main server of the group D, the main servers 101E and 101F of the other groups E and F of the super group II to retrieve print jobs of the user X (Act 20A).

The image forming apparatus 105D receives the result of the retrieval in the group E from the main server 101E and the result of the retrieval in the group F from the main server 101F via the high-order server 101D (Act 21).

Further, the image forming apparatus 105D instructs, via the high-order server 101D of the super group II, the high-order servers 101A and 101G of the other super groups I and III to retrieve print jobs of the user X (Act 20A).

The high-order server 101A retrieves print jobs of the user X in the group A based on the job list 43 thereof. The high-order server 101A instructs the other main servers 101B and 101C to retrieve print jobs of the user X based on the address list 41. In this way, the high-order server 101A retrieves print jobs of the user X in the super group I. The high-order server 101G retrieves print jobs of the user X in the super group III in the same way.

The image forming apparatus 105D receives, from the high-order servers 101A and 101G, the result of the retrieval from the super groups I and III via the high-order server 101D (Act 21).

The image forming apparatus 105D displays the retrieval result screen 81 on which the print jobs of the user X retrieved from the super groups I-III are displayed (Act 22) .

The user X selects the print job Abcd1 to be executed and presses the ‘print’ button 812. In this way, the image forming apparatus 105D receives an instruction for the execution of the print job Abcd1 (Act 15).

The image forming apparatus 105D executes the selected print job Abcd1 (Act 16) . If the print job Abcd1 is registered in either of the other groups E and F of the super group II, the image forming apparatus 105D acquires the print job Abcd1 via the main server 101E or 101F.

If the print job Abcd1 is registered in either of the other super groups I and III, the image forming apparatus 105D acquires the print job Abcd1 from the image forming apparatus 104A in which the print job Abcd1 is registered via the high-order servers 101A and 101D.

The image forming apparatus 105D maintains the job list 43 as the executed print job Abcd1 is not included in the job list 43 (Act 17: No).

The image forming apparatus 105D notifies, via the high-order server 101D, the high-order server 101A of the super group I of the execution of the print job Abcd1 (Act 19). The high-order server 101A deletes the print job Abcd1 from the job list 43. The other image apparatuses (101A-110A except for 101A) in the group A update the job lists 43 thereof to be the same as the print job 43 of the high-order server 101A.

Further, in a case where the main server 101E in the group E different from the group D to which the image forming apparatus 105D executing the print job Abcd1 belongs functions as a high-order server 101E, the image forming apparatus 105D sends an instruction for retrieval in the other super groups I and III via the main server 101D and the high-order server 101E.

Whether or not the retrieval among main servers is permitted may also be set in the address list 41. For example, if the retrieval between the main servers 101A and 101B is permitted, then the image forming apparatuses 101B-110B of the group B can retrieve a print job in the image forming apparatuses 101A-110A of the group A. For another example, if the retrieval between the main servers 101B and 101C is prevented, then the image forming apparatuses 101B-110B of the group B cannot retrieve a print job in the image forming apparatuses 101C-110C of the group C.

Whether or not the retrieval among the high-order servers 101A, 101D and 101G is permitted may also be set in the high-order address list 44.

After the button 811 displayed on the retrieval result screen 81 is pressed to retrieve print jobs in the other groups, the image forming apparatus 100 may only retrieve print jobs in the other groups (e.g. groups E and F) in the super group (e.g. the super group II) to which the image forming apparatus 100 belongs and display the result of the retrieval on the retrieval result screen 81. Then, the image forming apparatus 100 may display a button for retrieval in superior groups (e.g. the super groups I and III) on the retrieval result screen 81. If the button is pressed, then the image forming apparatus 100 can retrieve print jobs in super groups (e.g. the super groups I and III) different from the super group (e.g. the super group II) to which the image forming apparatus 100 belongs.

In the first and second embodiments, referring to FIG. 1, to retrieve the print job of a user registered in an image forming apparatus (e.g. 104A) belonging to a second group (e.g. group A) different from a first group (e.g. group B) to which the image forming apparatus (e.g. 105B) used by the user to execute the print job belongs, the following processing is carried out: the image forming apparatus (e.g. 105B) instructs the main server (e.g. 101A) of the second group (e.g. group A) to retrieve a print job of the user via the main server (e.g. 101B) of the first group (e.g. group B).

In the first and second embodiments, the workload of the retrieval of print jobs is distributed to the main server of each group, and no heavy workload is distributed to the majority of image forming apparatuses. Thus, in the first and second embodiments, even if the print system is composed of a plurality of image forming apparatuses, the user can use the image forming apparatus without any pressure. For this reason, it can be set in the first and second embodiments that the print system is composed of a plurality of image forming apparatuses.

In the first and second embodiments, an image forming apparatus first retrieves print jobs of a user in a first group and displays a retrieval result and, if instructed by the user to retrieve print jobs later, retrieves print jobs in a second group. Consequentially, if the print jobs of the user are registered in the first group, then the image forming apparatus can display the print jobs retrieved as soon as possible without carrying out a retrieval processing in vain in the second group.

As stated above, according to the technology described herein, an image forming apparatus is provided which can be used to form a location free print system.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus capable of forming a location free print system, the image forming apparatus comprising a computer readable storage medium having program instructions embodied therewith, the program instructions executable by a processing component to cause the processing component to:
share a first list of print jobs with a second image forming apparatus, the image forming apparatus and the second image forming apparatus included in a first group of the location free print system;
share an address list with a third image forming apparatus, the third image forming apparatus being a main server of a second group of the location free print system;
determine whether an entity is authorized to operate the image forming apparatus;
retrieve a print job from the first list of print jobs based on determining that the entity is authorized to operate the image forming apparatus and the print job being included in the first list of print jobs; and
instruct the third image forming apparatus to retrieve the print job from a second list of print jobs based on determining that the entity is authorized to operate the image forming apparatus and the print job being included in the second list of print jobs, and
wherein the second list of print jobs is shared by the third image forming apparatus with a fourth image forming apparatus included in the second group.

2. The image forming apparatus according to claim 1, wherein the program instructions further cause the processor component to:
instruct the second image forming apparatus to function as a main server of the first group based on the image forming apparatus initiating a power-off procedure.

3. The image forming apparatus according to claim 1, wherein the program instructions further cause the processor component to:
generate a priority list specifying a priority of the second image forming apparatus and a fifth image forming apparatus, the fifth image forming apparatus included in the first group; and
instruct another image forming apparatus to function as a main server of the first group based on the image forming apparatus initiating a power-off procedure, the another image forming apparatus having highest priority on the priority list and being one of the second image forming apparatus or the fifth image forming apparatus.

4. The image forming apparatus according to claim 1, wherein the program instructions further cause the processor component to:
display a screen on a display section based on the retrieving of the print job from the first list of print jobs, the display section configured to receive an input that determines whether to retrieve a second print job from the second list of print jobs; and
instruct the third image forming apparatus to retrieve the second print job based on a determination from the input to retrieve the second print job.

5. The image forming apparatus according to claim 1, wherein the address list comprises information indicating whether the third image forming apparatus is permitted to retrieve the print job in response to the instruction by the image forming apparatus.

6. A print job retrieval method by an image forming apparatus in a location free print system in which groups of networks made up of a plurality of image forming apparatuses include one image forming apparatus functioning as a main server and an address list of addresses of main servers of all groups is shared by the main server of each group, the print job retrieval method comprising:
causing a list of print jobs to be shared by each image forming apparatus in a first group, the image forming apparatus included in the first group;
authenticating a user;
retrieving a print job of the user from the list of print jobs based on the authentication of the user and the print job being included in the list of print jobs; and
instructing, via a main server of the first group, a main server of a second group to retrieve the print job from a second list of print jobs that is shared in the second group based on the authentication of the user and the print job being included in the second list of print jobs.

7. The print job retrieval method according to claim 6, further comprising:
instructing a second image forming apparatus to function as the main server of the first group based on the main server of the first group initiating a power-off procedure, the second image forming apparatus included in the first group.

8. The print job retrieval method according to claim 6, further comprising:
generating a priority list that specifies a priority of a second image forming apparatus and a third image forming apparatus, the second image forming apparatus and the third image forming apparatus included in the first group; and
instructing another image forming apparatus to function as the main server of the first group based on the main server of the first group initiating a power-off procedure, the another image forming apparatus having highest priority on the priority list and being one of the second image forming apparatus or the third image forming apparatus.

9. The print job retrieval method according to claim 6, further comprising:
displaying a screen on a display section based on the retrieving of the print job from the list of print jobs, the display section configured to receive an input that determines whether to retrieve a second print job from the second list of print jobs; and
instructing the main server of the second group to retrieve the second print job based on a determination from the input to retrieve the second print job.

10. The print job retrieval method according to claim 6, wherein the address list comprises information indicating whether the main server of the second group is permitted to retrieve the print job in response to the instructing by the main server of the first group.
